(19) United States
(12) Patent Application Publication
(10) Pub. No.: US 2026/0073420 A1
(43) Pub. Date: Mar. 12, 2026

(54) Advertising Provision System, Method, and Program

(71) Applicant: Daisuke NAGAYAMA, Tokyo (JP)

(72) Inventor: Daisuke NAGAYAMA, Tokyo (JP)

(21) Appl. No.: 19/323,781

(22) Filed: Sep. 9, 2025

(30) Foreign Application Priority Data
Sep. 9, 2024 (JP) 2024-155225

(51) Int. Cl. G06Q 30/0207

(52) U.S. Cl. CPC G06Q 30/0219

(57) ABSTRACT

An advertising provision system, method, and program are provided for displaying advertising content together with a two-dimensional code indicating the remaining allowable number of reads. The system updates the count in real time when the code is read by a user terminal, and transmits award information if the remaining count is greater than zero. When the count reaches zero, the system notifies that the award has expired. The system can also manage multiple advertisements and codes within a single display, allowing simultaneous campaigns. This creates urgency for users to promptly act, thereby improving the effectiveness of the advertisement.

### CROSS-REFERENCE TO RELATED APPLICATIONS

This application claims the award of Japanese Patent Application No. 2024-155225, filed on Sep. 9, 2024, the entire contents of which are incorporated herein by reference.

### FIELD OF THE INVENTION

The present invention relates to advertising provision technology, and more particularly to a system, method, and program for providing advertising content together with two-dimensional codes, enabling users to obtain awards associated with advertised products or services.

### BACKGROUND OF THE INVENTION

Conventionally, advertising provision methods using advertising media such as digital signage and mass media have been widely adopted.

In addition, methods for enhancing the advertising effect of such advertisements have also been employed.

For example, Japanese Patent Laid-Open Publication No. 2021-192274 discloses a method for displaying advertisements on digital signage that are associated with the characteristics of a user having a communication terminal.

However, in the technology disclosed in the above-mentioned patent publication, although it can be expected to improve the advertising effect by displaying advertisements related to users near the digital signage, there remain uncertainties as to whether the users will actually become interested in, or purchase, the advertised products.

Accordingly, it is an object of the present invention to provide an advertising provision method capable of further enhancing the advertising effect.

### SUMMARY OF THE INVENTION

According to one aspect of the present invention, there is provided an advertisement provision method implemented by an advertisement provision terminal connected to a server terminal via a network. The server terminal causes, via the advertisement provision terminal, a two-dimensional code to be displayed together with an advertisement, receives a reading request for the two-dimensional code from a user terminal, and updates the number of times the two-dimensional code can be read.

According to the advertising provision method of the present invention, the advertising effect can be further enhanced.

### BRIEF DESCRIPTION OF THE DRAWINGS

FIG. 1 is a block diagram illustrating the configuration of the advertising provision system according to an embodiment of the invention.

FIG. 2 is a functional block diagram of the server terminal shown in FIG. 1.

FIG. 3 is a functional block diagram of the advertising provision terminal shown in FIG. 1.

FIG. 4 is a functional block diagram of the user terminal shown in FIG. 1.

FIG. 5 is a diagram showing an example of advertising data stored in the server terminal.

FIG. 6 is a diagram showing an example of two-dimensional code management data stored in the server terminal.

FIG. 7 is an example of a flowchart of an advertising provision method according to a first embodiment of the present invention.

FIG. 8 is an example of a display in which a QR code is displayed along with advertising information of the advertiser on digital signage.

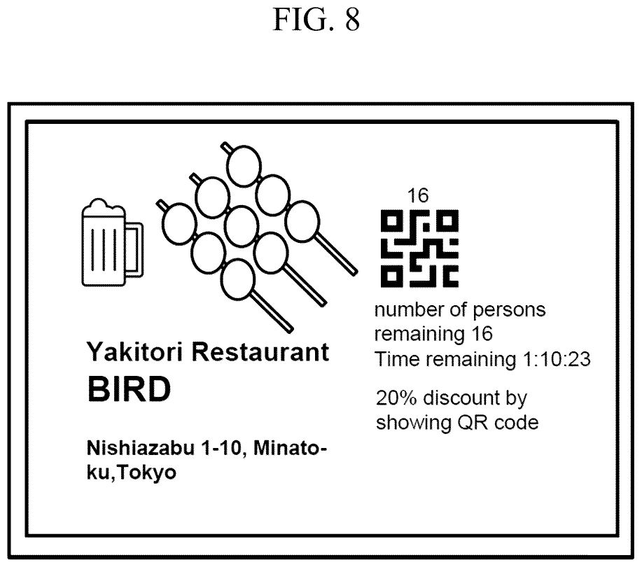

FIG. 9 is an example of a flowchart of an advertising provision method according to a second embodiment of the present invention.

FIG. 10 is an example of a display in which a QR code is displayed along with advertising information of the advertiser on digital signage.

FIG. 11 is an example of a two-dimensional code map guiding users to the stores, displayed on the user terminal, according to a second embodiment of the present invention.

### DETAILED DESCRIPTION OF THE PREFERRED EMBODIMENTS

The embodiments of the present invention will now be described below with reference to the accompanying drawings. It should be noted that the embodiments described below are not intended to unduly limit the scope of the invention as recited in the claims. Further, not all of the components shown in the embodiments are necessarily essential elements of the invention.

### Embodiment 1

### Configuration

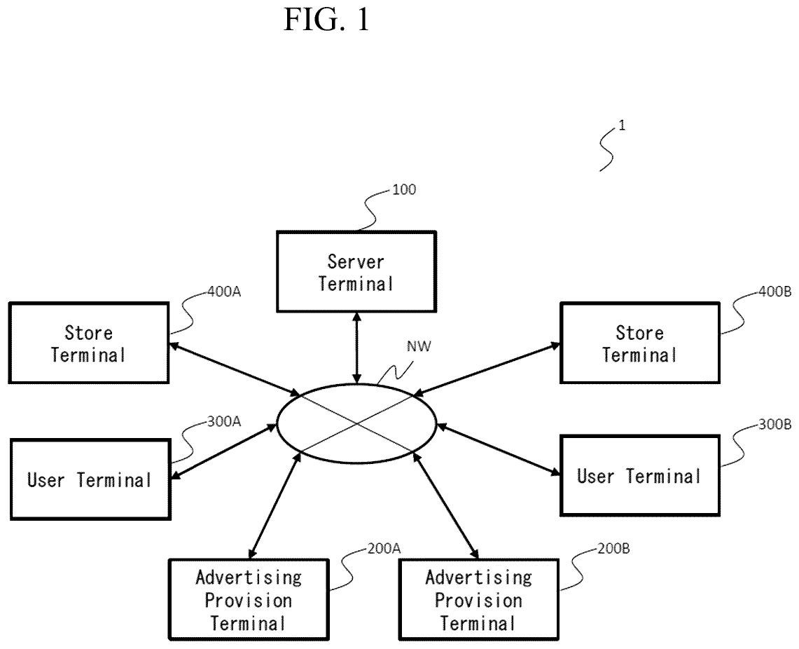

FIG. 1 is a block diagram showing an advertising provision system according to a first embodiment of the present invention. The system 1 of the present embodiment includes: a server 100; a plurality of advertising provision terminals 200A, 200B (in this example, digital signage devices) connected to the server via a network; a plurality of user terminals 300A, 300B; and a plurality of store terminals 400A, 400B.

The server terminal 100, the advertising provision terminals 200A, 200B, and the user terminals 300A, 300B are each connected via a network NW. The network NW may be configured using the Internet, an intranet, a wireless LAN (Local Area Network), a WAN (Wide Area Network), or the like.

The server terminal 100 manages advertising data relating to advertisements provided by an advertiser, as well as two-dimensional code management data relating to two-dimensional codes (in this example, QR Codes®) that enable access to award information regarding advertised products or services provided in association with the advertising data. The server terminal 100 provides the advertising provision terminal 200 with advertising content and the two-dimensional code associated with the advertising content as advertising data. The server terminal 100 may be, for example, a general-purpose computer such as a workstation or personal computer, or may be logically implemented through cloud computing. In the present embodiment, for the sake of convenience in explanation, a single server terminal is illustrated as an example, but the invention is not limited thereto and multiple servers may be used.

The advertising provision terminals 200A and 200B display the advertising content provided from the server 100 as advertising data, and also display the two-dimensional code associated with the advertising content. In the present embodiment, for example, the advertising provision terminals 200A and 200B may be implemented as digital signage devices installed in locations such as storefronts or street locations where they can be viewed by pedestrians.

The user terminals 300A and 300B are terminals owned by users such as pedestrians, and examples include smartphones and tablet devices. A user, via the user terminal 300A or 300B, reads the two-dimensional code displayed on the advertising provision terminal 200 by capturing it with a camera built into the user terminal 300A or 300B. By selecting link information (URL) displayed on the user terminal 300A or 300B for award information relating to the advertised product or service (and/or an application/registration screen, hereinafter referred to as “award information”), the user accesses the server terminal 100 (or an advertiser terminal not shown). The store terminals 400A and 400B are terminals managed by facilities such as shopping malls or stations, and by stores providing products or services. These store terminals can scan a coupon (two-dimensional code) corresponding to the award information displayed on the user terminals 300A or 300B, or can scan a coupon (two-dimensional code) granted via an application of the advertiser and/or an affiliated store installed on the user terminals 300A or 300B as a condition for granting the award, and then execute a checkout process applying the award such as a discount, and send information to the server terminal 100 indicating that the award has been redeemed.

For convenience of explanation, the advertising provision terminals 200A and 200B will be collectively referred to below as “advertising provision terminal 200,” and the user terminals 300A and 300B will be collectively referred to below as “user terminal 300.”

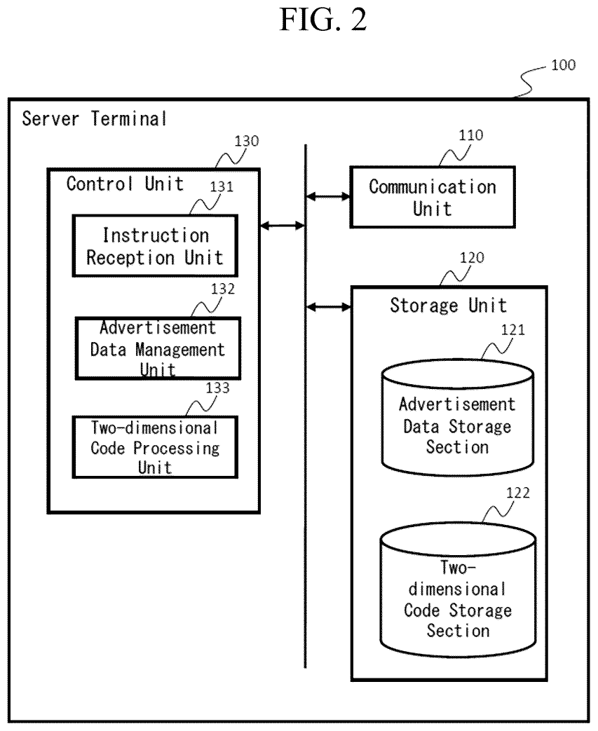

FIG. 2 is a functional block diagram of the server terminal 100 shown in FIG. 1. The server terminal 100 includes a communication unit 110, a storage unit 120, and a control unit 130.

The communication unit 110 is a communication interface for communicating with the user terminal 200 and an external service provider terminal 300 via the network NW. Communication is performed in accordance with communication protocols such as TCP/IP (Transmission Control Protocol/Internet Protocol).

The storage unit 120 stores programs for executing various control processes and functions within the control unit 130, as well as input data and the like, and is configured from RAM (Random Access Memory), ROM (Read Only Memory), or the like. The storage unit 120 also includes an advertisement data storage section 121 for storing various types of data relating to advertisements, and a two-dimensional code management data storage section 122 for storing various types of data relating to two-dimensional codes associated with the advertising content. Furthermore, the storage unit 120 can temporarily store data communicated with the advertising provision terminal 200 and the user terminal. It should be noted that a database (not shown) storing various types of data may be constructed in the storage unit 120 or outside the server terminal 100.

The control unit 130 controls the overall operation of the server terminal 100 by executing programs stored in the storage unit 120, and is constituted by, for example, a CPU (Central Processing Unit), a GPU (Graphics Processing Unit), or the like. Functions of the control unit 130 include: an instruction reception unit 131 for receiving input from the advertising provision terminal 200 or the user terminal 300; an advertisement data management unit 132 for referencing and processing various types of data relating to advertisements; and a two-dimensional code processing unit 133 for performing processes relating to two-dimensional codes. The instruction reception unit 131, the advertisement data management unit 132, and the two-dimensional code processing unit 133 are started by programs stored in the storage unit 120 and are executed by the server terminal 100, which is a computer (electronic computer).

The instruction reception unit 131 receives an instruction from the advertising provision terminal 200 or the user terminal 300 via the communication unit 110 when a user performs a predetermined input operation on the advertising provision terminal 200 or the user terminal 300.

The advertisement data management unit 132 manages and processes various types of data related to advertisements (for example, advertiser information, advertising content information, advertising display timing information, advertising display location, award information, award condition information, and the like).

The two-dimensional code processing unit 133 manages two-dimensional codes associated with advertising content and performs predetermined processing.

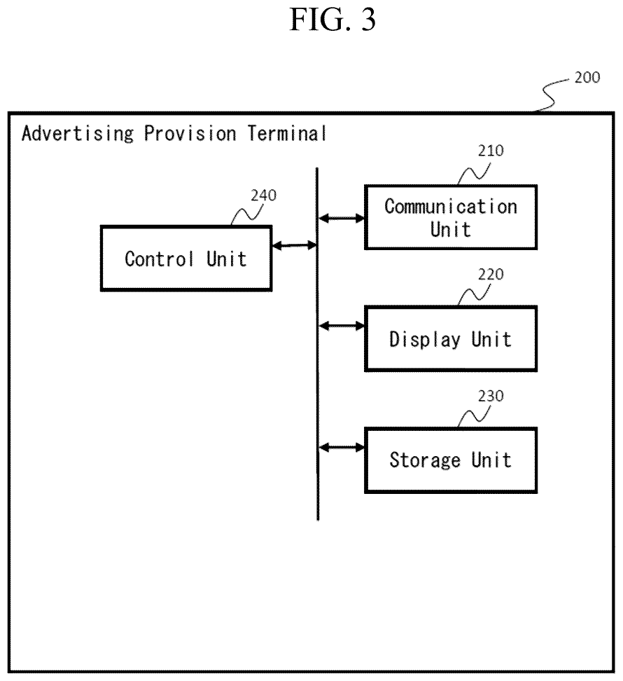

FIG. 3 is a functional block diagram illustrating the advertising provision terminal 200 shown in FIG. 1. The user terminal 200 includes a communication unit 210, a display unit 220, a storage unit 230, and a control unit 240.

The communication unit 210 is a communication interface for communicating with the server terminal 100 via the network NW, and communication is performed in accordance with communication protocols such as TCP/IP.

The display unit 220 is configured from a display panel or the like, which is used to display text, images, and the like in accordance with input data such as advertising content from the control unit 250.

The storage unit 230 stores programs for executing various control processes and functions within the control unit 250, input data such as advertising content, and the like, and is configured from RAM, ROM, or the like. The storage unit 230 also temporarily stores communication content with the server terminal 100.

The control unit 240 controls the overall operation of the user terminal 200 by executing programs stored in the storage unit 230, and is constituted by, for example, a CPU or a GPU.

It should be noted that the server terminal 100 may be configured to include the functions of the display unit, in which case it is possible to adopt a configuration that does not include the advertising provision terminal 200.

It should also be noted that the functional block configuration of the external service provider terminal 300 may be substantially the same as that of the user terminal 200, and therefore a detailed description thereof will be omitted.

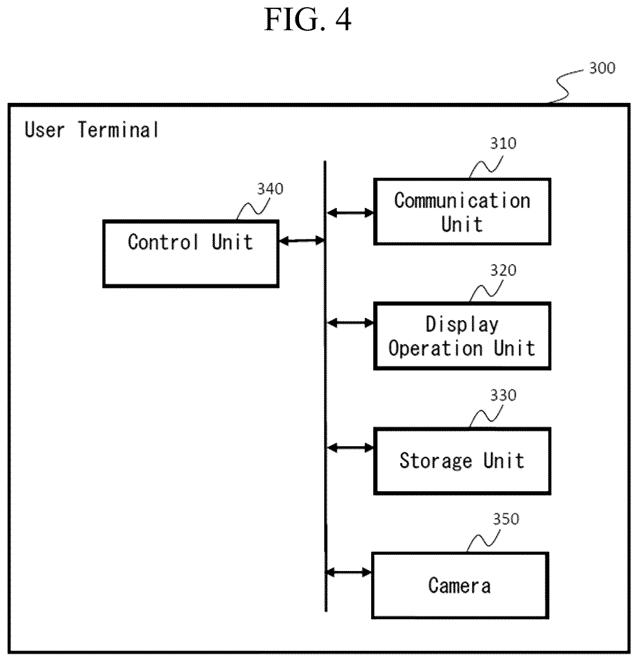

FIG. 4 is a functional block diagram illustrating the user terminal 300 shown in FIG. 1. The user terminal 300 includes a communication unit 310, a display operation unit 320, a storage unit 330, a control unit 340, and a camera 350.

The communication unit 310 is a communication interface for communicating with the server terminal 100 via the network NW, and communication is performed in accordance with communication protocols such as TCP/IP.

The display operation unit 320 is a user interface used for receiving input instructions from a user and for displaying text, images, and the like according to input data from the control unit 340. When the user terminal 300 is configured as a personal computer, the display operation unit 320 is constituted by a display in combination with a keyboard and a mouse. When the user terminal 300 is configured as a smartphone or a tablet terminal, the display operation unit 320 is constituted by a touch panel or the like. The display operation unit 320 is activated by a control program stored in the storage unit 330 and executed by the user terminal 300, which is a computer (electronic computer).

The storage unit 330 stores programs for executing various control processes and functions in the control unit 340, input data, and the like, and is constituted from RAM, ROM, or the like. The storage unit 330 also temporarily stores communication content with the server terminal 100.

The control unit 340 controls the overall operation of the user terminal 300 by executing programs stored in the storage unit 330, and is constituted by, for example, a CPU or a GPU.

In the present embodiment, the camera 350 captures images to read a two-dimensional code displayed on the advertising provision terminal 200.

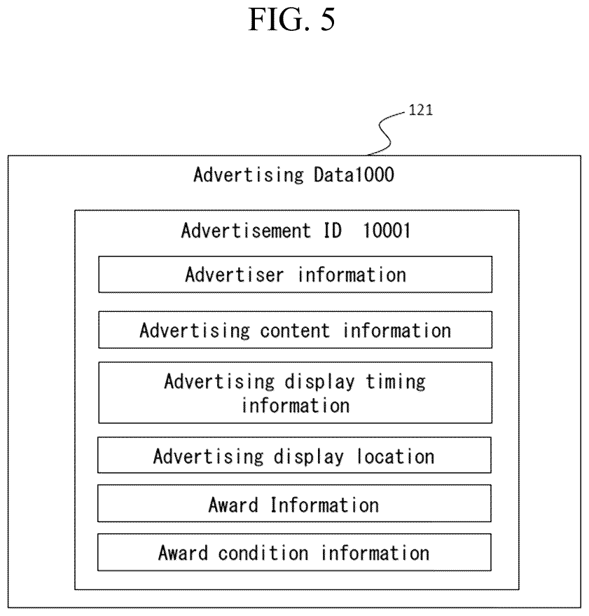

FIG. 5 is a diagram illustrating an example of advertising data stored in the server 100.

The advertising data 1000 shown in FIG. 5 stores various data related to advertisements. In FIG. 5, for convenience of explanation, an example of a single advertisement (an advertisement identified by advertisement ID “10001”) is shown; however, information for a plurality of advertisements may be stored. Here, the term “advertisement” refers to content provided by an advertiser for the purpose of promoting the advertiser's products or services to specific or unspecified users. Examples of advertisers include, for example, product providers and store operators. The advertiser may be the same as, or different from, the medium providing the advertised product (such as a store or other location where the user can enjoy the awards). Examples of various data related to advertisements include advertiser information (such as the name and other basic information of the advertiser), advertising content information (content data, such as images or text, for promoting the advertised product/service), advertising display timing information (such as the date and time at which the advertisement is to be displayed), advertising display location (the place where the advertisement is displayed, identification information of the advertising provision terminal, etc.), award information (such as coupons for the advertised product/service), and award condition information (conditions for granting a award or a two-dimensional code, such as presenting the two-dimensional code, showing a smile to a store clerk, or performing a gesture imitating the advertiser's logo in front of signage). Here, “award information” includes not only information for receiving awards related to the advertised product/service, but also detailed information about the advertised product/service, application information, and the like.

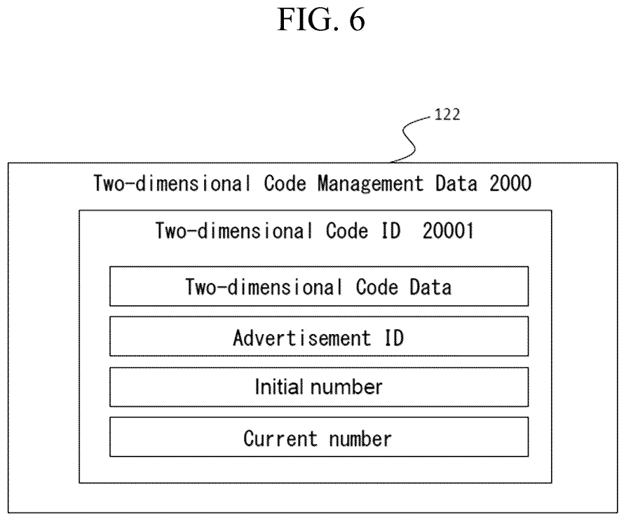

FIG. 6 is a diagram illustrating an example of two-dimensional code management data stored in the server 100.

The two-dimensional code management data 2000 shown in FIG. 6 stores data related to a two-dimensional code associated with advertising content. In FIG. 6, for convenience of explanation, an example of information related to a single two-dimensional code (data identified by two-dimensional code ID “20001”) is shown; however, information related to a plurality of two-dimensional codes may be stored. Examples of various data related to two-dimensional codes include data for generating/displaying the two-dimensional code (in this example, a QR code), an advertisement ID associated with the two-dimensional code, an upper limit on the number of times the two-dimensional code can be read, the number of times the two-dimensional code has been read, and the like.

FIG. 6 is an example of a flowchart of an advertising provision method according to a first embodiment of the present invention.

First, in step SQ101, the control unit 130 of the server terminal 100 transmits, to the advertising provision terminal 200, data relating to advertising content as advertising data. The advertising data is stored in advance in the storage unit 120 of the server terminal, and the advertising content included in the advertising data contains image data and text data relating to the advertised product/service.

Next, in step SQ102, the control unit 130 of the server terminal 100 transmits, to the advertising provision terminal 200, data necessary for displaying a QR code as two-dimensional code data. The two-dimensional code data is generated as data related to the advertising content (and the advertised product/service linked thereto) and is stored in advance in the storage unit 120 of the server terminal 100.

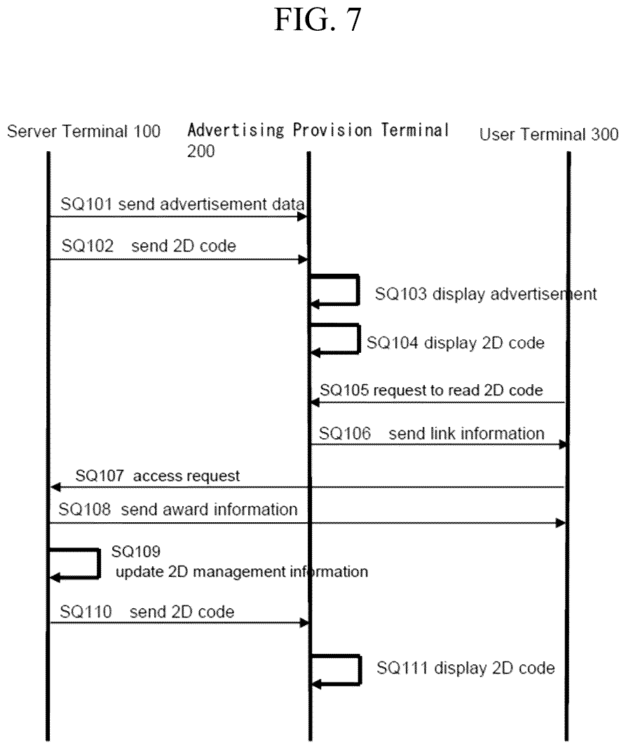

In step SQ103, the control unit 240 of the advertising provision terminal 200 displays the advertising content on the display unit 220 based on the received data relating to the advertising content. In step SQ104, the control unit 240 displays the QR code on the display unit 220 based on the received data for displaying the QR code. Here, the control unit 240 may display, adjacent to the QR code, the number of allowable remaining reads (an initial value or remaining count). FIG. 7 shows an example of a display in which a QR code is displayed along with store advertising information on digital signage. As shown in FIG. 7, the digital signage displays a promotional advertisement for a yakitori restaurant and award information for obtaining a coupon, together with a QR code. Near the QR code, the remaining number of times the QR code can be read to obtain the coupon (i.e., the number of coupons remaining) is displayed. Furthermore, as a condition for displaying the QR code, in advance, award condition information is stored in the storage unit 120 of the server terminal 100, such that, for example, when a predetermined action (such as performing a gesture imitating the advertiser's logo) is carried out by a user in front of the advertising provision terminal 200, a camera built into the advertising provision terminal 200 detects the predetermined action (such as forming the shape of the advertiser's logo using the user's body). Based on this detection, the control unit 240 of the advertising provision terminal 200 may refer to the award condition information previously received from the server terminal 100 and display the QR code on the display unit 220.

Next, in step SQ105, the user terminal 300 issues a QR code reading request by capturing the QR code displayed on the advertising provision terminal 200 with the camera 350. In this example, for instance, a user who is a pedestrian on the street may notice advertising content and a QR code projected on digital signage installed outdoors and may read the QR code with their smartphone to obtain a coupon for the advertised product. The user, seeing the remaining allowable read count displayed next to the QR code, may be motivated to quickly obtain the coupon. Then, in step SQ106, the advertising provision terminal 200, in response to the QR code reading request from the user terminal 300, transmits to the user terminal 300 link information in the form of a URL of a webpage that provides award information for the advertised product/service.

Next, in step SQ107, when the user operates the user terminal 300 to select the link information (URL) displayed on the user terminal 300, the control unit 340 of the user terminal 300 transmits an access request to the server terminal 100 for the webpage providing the award information.

Next, in step SQ108, the control unit 240 of the server terminal 100, in response to the access request from the user terminal 300, transmits the relevant webpage to the user terminal 300. In step SQ109, the control unit 240 of the server terminal 100 transmits to the user terminal 300 information for displaying a webpage that provides the award information (for example, a description of the award details and a two-dimensional code (such as a QR code) to be presented at the store). At the time of checkout for the product or service at the store, the store terminal 400 reads the two-dimensional code (such as a QR code) displayed on the user terminal 300 using a scanner built into or attached to the store terminal, performs a discount process based on the award information from the product or service price, executes a purchase process for the product or service, and transmits to the server terminal 100 information indicating that the purchase process has been executed. For example, when a store clerk, at the time of checkout, directly reads with the store terminal 400 the QR code displayed on the user terminal 300 (captured from the advertising provision terminal 200), the purchase process may be executed by performing a discount process without displaying the above-mentioned award information, and instead, the process may transmit information for displaying a webpage such as a discount process confirmation screen.

Here, in step SQ110, the two-dimensional code processing unit 240 of the server terminal 100, based on the above-described access request from the user terminal 300 or on receipt of information from the store terminal 400 indicating that the purchase has been completed, updates the current allowable read count of the two-dimensional code by subtracting the current reading instance from the allowable read count (for example, by updating the count by subtracting “1” from the read count prior to reading the QR code). The two-dimensional code processing unit 240 may also decrease the allowable read count of the QR code, instead of in response to the above-described access request, upon occurrence of an event such as the user purchasing the advertised product/service or submitting an application.

Subsequently, in step SQ111, the control unit 130 of the server terminal 100 transmits, to the advertising provision terminal 200, data necessary for displaying a QR code as two-dimensional code data. The two-dimensional code data is generated as data related to the advertising content (and the advertised product/service linked thereto) and is stored in advance in the storage unit 120 of the server terminal 100. In step SQ111, the control unit 240 of the advertising provision terminal 200 displays the QR code on the display unit 220 based on the received data for displaying the QR code. Here, the control unit 240 may display, adjacent to the QR code, the allowable read count (number of times).

As described above, by displaying the allowable read count of a two-dimensional code displayed together with advertising data, and by updating the allowable read count in the server terminal each time the two-dimensional code is read and an access to a webpage related to a product/service associated with the advertising data is made via link information associated with the two-dimensional code, and displaying the updated, decremented count on the advertising terminal, it is possible to motivate the user to pay attention to the advertisement, and ultimately, to motivate the user to quickly purchase or apply for the advertised product or service.

As another embodiment, the advertising terminal may also be applied to a display device such as a television broadcast receiving device, a smartphone, or a tablet.

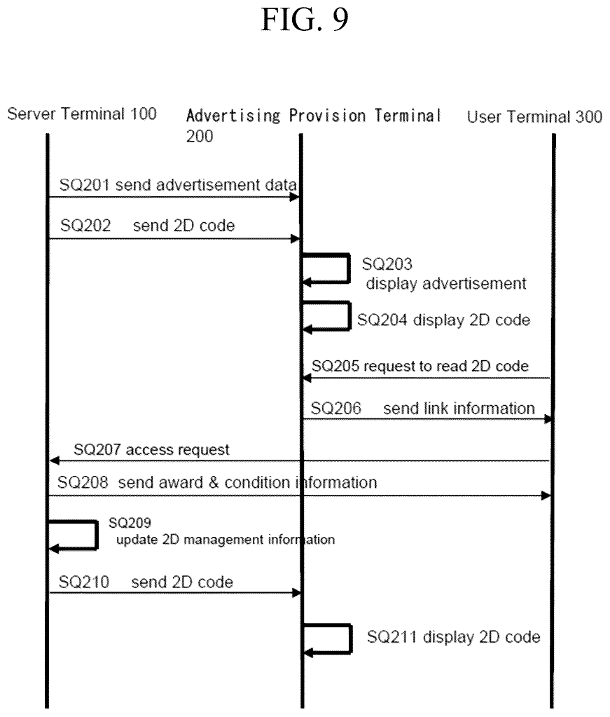

FIG. 9 is an example of a flowchart of an advertising provision method according to a second embodiment of the present invention. In this example, the case is described in which an advertiser (e.g., a facility operator such as a shopping mall or train station) provides a user with award information applicable to products or services offered by one or more stores (e.g., tenant stores in a shopping mall or train station facility) that are different from the advertiser itself.

First, in step SQ201, the control unit 130 of the server terminal 100 transmits, to the advertising provision terminal 200, data relating to advertising content as advertising data. The advertising data is stored in advance in the storage unit 120 of the server terminal, and the advertising content included in the advertising data contains image data and text data relating to the advertised product/service.

Next, in step SQ202, the control unit 130 of the server terminal 100 transmits, to the advertising provision terminal 200, data necessary for displaying a QR code as two-dimensional code data. The two-dimensional code data is generated as data related to the advertising content (and the advertised product/service linked thereto) and is stored in advance in the storage unit 120 of the server terminal 100.

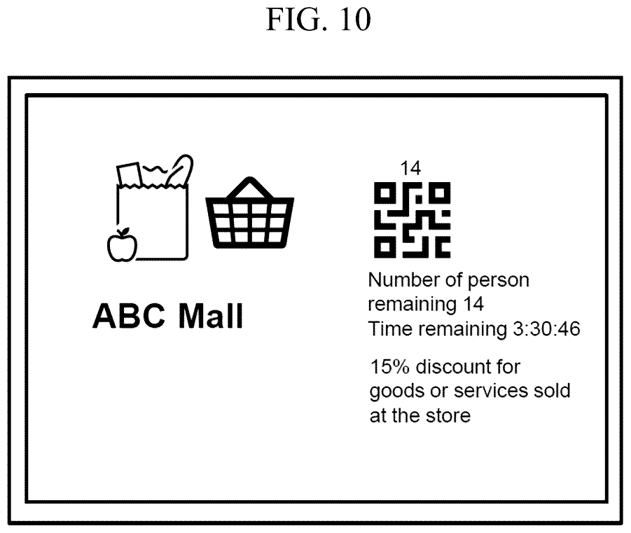

In step SQ203, the control unit 240 of the advertising provision terminal 200 displays the advertising content on the display unit 220 based on the received data relating to the advertising content. In step SQ204, the control unit 240 displays the QR code on the display unit 220 based on the received data for displaying the QR code. Here, the control unit 240 may display, adjacent to the QR code, the allowable read count (initial value or remaining count). FIG. 10 shows an example of a display in which a QR code is displayed along with advertising information of the advertiser (in this example, a shopping mall) on digital signage. As shown in FIG. 10, the digital signage displays award information (e.g., coupons) applicable to products or services offered by one or more stores in the shopping mall, together with the QR code. Near the QR code, the remaining allowable read count (i.e., the number of coupons remaining) for obtaining the coupon is displayed. Furthermore, as a condition for displaying the QR code, in advance, award condition information is stored in the storage unit 120 of the server terminal 100. For example, when a predetermined action (such as performing a gesture imitating the logo mark of the advertiser or tenant store) is set as a condition, a camera built into the advertising provision terminal 200 detects the predetermined action (such as forming the shape of the advertiser's logo mark using the user's body). Based on this detection, the control unit 240 of the advertising provision terminal 200 may refer to the award condition information previously received from the server terminal 100 and display the QR code on the display unit 220.

Next, in step SQ205, the user terminal 300 issues a QR code reading request by capturing the QR code displayed on the advertising provision terminal 200 with the camera 350. In this example, for instance, a user who is a pedestrian on the street may notice advertising content and a QR code projected on digital signage installed outdoors and may read the QR code with their smartphone to obtain a coupon from the advertiser. The user, seeing the remaining allowable read count displayed next to the QR code, may be motivated to quickly obtain the coupon. Then, in step SQ206, the advertising provision terminal 200, in response to the QR code reading request from the user terminal 300, transmits to the user terminal 300 link information in the form of a URL of a webpage that provides award information for the advertised product/service.

Next, in step SQ207, when the user operates the user terminal 300 to select the link information (URL) displayed on the user terminal 300, the control unit 340 of the user terminal 300 transmits an access request to the server terminal 100 for a webpage that provides the award information and award condition information.

Next, in step SQ208, the control unit 240 of the server terminal 100, in response to the access request from the user terminal 300, transmits to the user terminal 300 the corresponding webpage providing the award information and award condition information. In step SQ209, the control unit 240 of the server terminal 100 transmits to the user terminal 300 information for displaying a webpage providing the award information (e.g., a description of the award details and a two-dimensional code such as a QR code to be presented to the tenant store) and the award condition information (e.g., downloading an ABC Mall application, showing a smile to an in-store camera at XYZ Drug). The advertiser may, as award information and award condition information, set different award details and award condition information for each of a plurality of stores, and store them in the storage unit 120 of the server terminal 100. For example, as award information and award condition information provided by the advertiser (in this example, ABC Mall), the award details and award condition information set for each tenant store (in this example, XYZ Drug, JKL Supermarket, etc.) may be displayed in a list format on the user terminal 300. At the time of checkout for the product or service at the store, the store terminal 400 reads the two-dimensional code (e.g., QR code) displayed on the user terminal 300 using a scanner built into or attached to the store terminal 400, performs a discount process based on the award information from the product or service price, executes a purchase process for the product or service, and transmits to the server terminal 100 information indicating that the purchase process has been executed. For example, when a store clerk, at the time of checkout, directly reads with the store terminal 400 the QR code displayed on the user terminal 300 (captured from the advertising provision terminal 200), the purchase process may be executed by performing a discount process without displaying the above-mentioned award information, and instead, the process may transmit information for displaying a webpage such as a discount process confirmation screen.

Here, in step SQ210, the two-dimensional code processing unit 240 of the server terminal 100, based on the above-described access request from the user terminal 300 or on receipt of information from the store terminal 400 indicating that the purchase has been completed, updates the current allowable read count of the two-dimensional code by subtracting the current reading instance from the allowable read count (for example, by updating the count by subtracting “1” from the read count prior to reading the QR code). The two-dimensional code processing unit 240 may also decrease the allowable read count of the QR code, instead of in response to the above-described access request, upon occurrence of an event such as the user purchasing the advertised product/service or submitting an application.

Subsequently, in step SQ211, the control unit 130 of the server terminal 100 transmits, to the advertising provision terminal 200, data necessary for displaying a QR code as two-dimensional code data. The two-dimensional code data is generated as data related to the advertising content (and the advertised product/service linked thereto) and is stored in advance in the storage unit 120 of the server terminal 100. In step SQ111, the control unit 240 of the advertising provision terminal 200 displays the QR code on the display unit 220 based on the received data for displaying the QR code. Here, the control unit 240 may display, adjacent to the QR code, the allowable read count (number of times).

In the present embodiment, the advertiser (e.g., shopping mall operator) may set the allowable read count for a two-dimensional code (e.g., QR code) related to award information provided by the advertiser, and may also install individual advertising provision terminals 200A, 200B, etc. (e.g., digital signage) in each of a plurality of stores related to the advertiser (e.g., tenant stores in the shopping mall) to display two-dimensional codes (e.g., QR codes) for providing award information specific to each store. In this case, as awards provided by the advertiser (e.g., shopping mall), it is possible to provide common award information (e.g., a uniform 10% discount for all stores in the mall) while each store individually provides its own award information (e.g., an additional 15% discount at XYZ Drug). Moreover, it is possible to configure the system so that the user, after receiving awards provided by the advertiser via a two-dimensional code (e.g., QR code) with an allowable read count limit displayed on an advertising provision terminal corresponding to the advertiser (e.g., advertising provision terminal 200A), can also receive individual awards provided by each store via a two-dimensional code (e.g., QR code) with an allowable read count limit displayed on an advertising provision terminal corresponding to each store (e.g., advertising provision terminal 200B, etc.).

Further, via a two-dimensional code (e.g., QR code) with an allowable read count limit, the user terminal 300 may request access to a website providing award information and award condition information from the server terminal 100 in order to receive awards from the advertiser (e.g., shopping mall). In response to the access request, the server terminal 100 may display an installation screen for an application provided by the advertiser (e.g., an application operated by the shopping mall) and recommend installing the application on the user terminal 300 to receive the awards. The application is one that allows the user to receive awards related to products or services provided by the advertiser and stores or companies related to the advertiser. By reading, with a scanner or the like provided to a terminal corresponding to the advertiser (e.g., a store terminal 400A in the shopping mall) or to a terminal corresponding to a related store (e.g., a store terminal 200B, etc.), a two-dimensional code (e.g., QR code) displayed on the user terminal 300 via the application, the user can receive discounts or other awards for products or services provided by the advertiser or related stores. Each store terminal 400 transmits to the server terminal 100 information indicating that the award has been exercised, and the server terminal 100 may, as shown in FIG. 9, execute a process of decreasing the allowable read count of the two-dimensional code. Here, in relation to awards for products or services provided by the advertiser, based on detection by the server terminal 100 that the application has been installed on the user terminal 300 according to the above award condition information, the server terminal 100 may, as shown in FIG. 9, execute a process of decreasing the allowable read count of the two-dimensional code.

In this way, by combining or linking awards of the advertiser and related stores, it is possible to synergistically enhance customer attraction both to the facility operated by the advertiser and to individual stores.

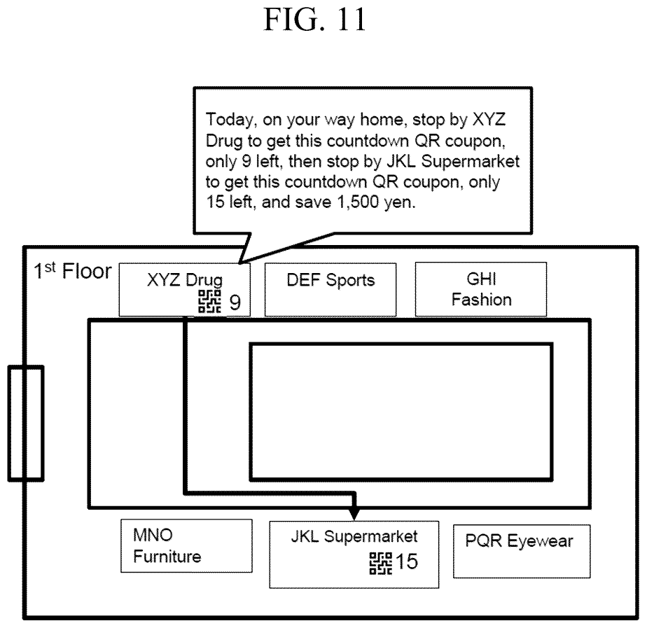

In the case, as in this example, where an advertising provision terminal is installed in each store in a shopping mall and a two-dimensional code is presented, the control unit 130 of the server terminal 100 may, as shown in FIG. 11, display on the user terminal 300 a map guiding the user to each store in the shopping mall (the advertiser) and display the allowable read count for the QR code granting awards corresponding to each store, and may send a notification to the user recommending store visits based on the allowable read count of each store's two-dimensional code stored in the storage unit 120 of the server terminal 100, such as, for example: “Today, on your way home, stop by XYZ Drug to get this countdown QR coupon, only 9 left, then stop by JKL Supermarket to get this countdown QR coupon, only 15 left, and save 1,500 yen.” In this case, the control unit 130 of the server terminal 100 may determine which store should be visited first based on the allowable read count and send a notification to the user terminal 300.

Thus, in the present embodiment, when the advertiser is associated with multiple stores, the advertiser can promote customer visits to multiple stores by providing award information for multiple stores together with a two-dimensional code having a set allowable read count to the user, while also working in coordination with individual similar measures of multiple stores to maximize customer attraction.

Although embodiments of the present disclosure have been described above, these embodiments may be implemented in various other forms, and various omissions, substitutions, and changes may be made without departing from the scope of the invention. Such embodiments and variations, as well as omissions, substitutions, and changes, are intended to fall within the scope of the technical range of the claims and the equivalents thereof.

1. An advertising provision system comprising:
a storage unit configured to store advertising content and award information in association with a two-dimensional code and a maximum allowable read count;
a control unit configured to transmit the advertising content to a display terminal for display together with the two-dimensional code and a remaining read count;
a communication unit configured to receive a read request from a user terminal that has read the two-dimensional code; and
the control unit further configured to, upon receipt of the read request, determine whether the remaining read count is greater than zero, and if so, decrement the count and transmit the award information to the user terminal, and if not, transmit a notification indicating that the award has expired.

2. The advertising provision system of claim 1, wherein the remaining read count is updated in real time on the display terminal.

3. The advertising provision system of claim 1, wherein the storage unit stores multiple sets of advertising content and associated two-dimensional codes, and the control unit manages the display of the multiple sets within a single display space.

4. The advertising provision system of claim 3, wherein the control unit updates the remaining read count for each two-dimensional code independently.
